(19) United States
(12) Patent Application Publication
(10) Pub. No.: US 2019/0273980 A1
(43) Pub. Date: Sep. 5, 2019

(54) WEARABLE ELECTRONIC DEVICES CONFIGURED TO INTERFACE WITH PORTABLE WIRELESS AUDIO DEVICES

(71) Applicant: Muzik Inc., West Hollywood, CA (US)

(72) Inventors: Jason Hardi, Beverly Hills, CA (US); James B. Hardi, Raleigh, NC (US); Elizabeth Hardi, Raleigh, NC (US)

(21) Appl. No.: 16/289,705

(22) Filed: Mar. 1, 2019

Related U.S. Application Data
(60) Provisional application No. 62/637,020, filed on Mar. 1, 2018.
(60) Provisional application No. 62/676,042, filed on May 24, 2018.
(60) Provisional application No. 62/744,222, filed on Oct. 11, 2018.
(60) Provisional application No. 62/669,452, filed on May 10, 2018.
(60) Provisional application No. 62/669,467, filed on May 10, 2018.

(51) Int. Cl. H04R 1/10; H04R 1/02

(52) U.S. Cl. CPC H04R 1/1025; H04R 2420/07; H04R 1/1016; H04R 1/02

(57) ABSTRACT

A wearable electronic device can include a hinge configured to move the wearable electronic device between an open position and a closed position. First and second arc shaped portions can be moveable connected together at the hinge. A first recess in a face the first arc shaped portion can be located opposite the hinge, wherein the face the first arc shaped portion is exposed in the open position and is hidden in the closed position. A second recess in a face the second arc shaped portion can be located opposite the hinge, the first and second recesses being located in the first and second faces opposite one another, wherein the face the second arc shaped portion is exposed in the open position and is hidden in the closed position. A battery can be inside the first arc shaped portion, coupled to the first recess and configured electrically charge a portable wireless audio device when inserted into the first recess.

### CROSS-REFERENCE TO RELATED APPLICATION AND CLAIM FOR PRIORITY

The present application is related to and claims priority to U.S. Provisional Patent Application Ser. No. 62/637,020; filed Mar. 1, 2018 entitled Wearable Electronic Devices Configured to Interface with Portable Wireless Audio Devices; to U.S. Provisional Patent Application Ser. No. 62/676,042; filed May 24, 2018 entitled Wearable Electronic Devices Configured to Carry and/or Interface with Portable Wireless Audio Devices; to U.S. Provisional Patent Application Ser. No. 62/744,222; filed Oct. 11, 2018 entitled Wearable Electronic Devices Configured to Interface with Portable Wireless Audio Devices; to U.S. Provisional Patent Application Ser. No. 62/669,452; filed May 10, 2018 entitled Visual Interactive Platform; and to U.S. Provisional Patent Application Ser. No. 62/669,467; filed May 10, 2018 entitled Extended Reality Shopping Experience, the disclosures of which are incorporated herein by reference.

### BACKGROUND

Portable wireless audio devices, sometimes referred to as “earbuds,” have become a popular device for audio listening. The form-factor and wireless nature of some types of earbuds can make it more likely that those devices may be lost or misplaced.

### SUMMARY

Embodiments according to the invention can provide wearable electronic devices configured to interface with portable wireless audio devices. Pursuant to these embodiments, a wearable electronic device can include a hinge configured to move the wearable electronic device between an open position and a closed position. First and second arc shaped portions can be moveable connected together at the hinge. A first recess in a face the first are shaped portion can be located opposite the hinge, wherein the face the first are shaped portion is exposed in the open position and is hidden in the closed position. A second recess in a face the second arc shaped portion can be located opposite the hinge, the first and second recesses being located in the first and second faces opposite one another, wherein the face the second arc shaped portion is exposed in the open position and is hidden in the closed position. A battery can be inside the first arc shaped portion, coupled to the first recess and configured electrically charge a portable wireless audio device when inserted into the first recess.

### BRIEF DESCRIPTION OF THE DRAWINGS

FIGS. 1A and 1B are schematic representations of a Wearable Electronic Device that is configured to hold portable Wireless Audio Devices in a convenient and secure format for transportation, storage and/or charging of the Wireless Audio Devices in some embodiments.

FIG. 2 is a block diagram of the wearable electronic device including a battery that can be used to charge a portable wireless audio device in some embodiments.

FIGS. 3A to 3D illustrate a necklace format of the Wearable Electronic Device held by a cable around the user's neck in some embodiments.

FIGS. 4A to 5B illustrate formats wherein the Wearable Electronic Device is configured to wrap around the user's wrist or other appendage by a portion of a band in some embodiments.

FIGS. 6-8 show embodiments wherein the recesses are located on the same end of the Wearable Electronic Device which is in the form factor of a USB or memory stick/key fob arrangement which can be worn around any appendage of the user in some embodiments.

FIG. 9 is a schematic illustration of the wearable electronic device according to present inventive concepts is illustrated within an operating environment some embodiments.

### DETAILED DESCRIPTION

Advantages and features of present inventive concepts may be understood more readily by reference to the following detailed description of example embodiments and the accompanying drawings. The present inventive concepts may, however, be embodied in many different forms and should not be construed as being limited to the example embodiments set forth herein. Rather, these example embodiments are provided so that this disclosure will be thorough and complete and will fully convey present inventive concepts to those skilled in the art, and present inventive concepts will only be defined by the appended claim(s). Like reference numerals refer to like elements throughout the specification.

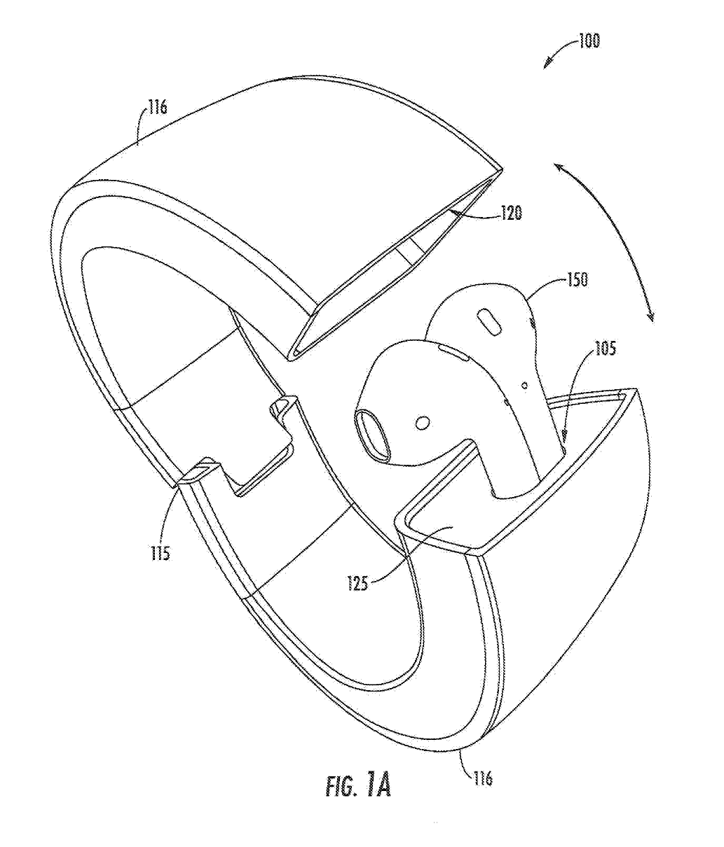

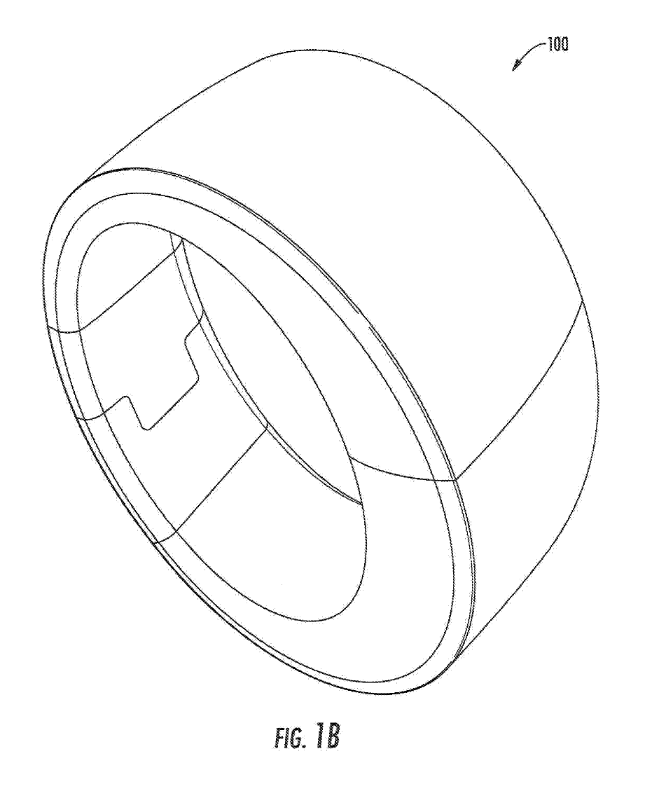

FIGS. 1A and 1B are schematic representations of a Wearable Electronic Device 100 that is configured to hold portable Wireless Audio Devices 150 in a convenient and secure format for transportation, storage and/or charging of the Wireless Audio Devices 150. According to FIGS. 1A and 1B the Wearable Electronic Device 100 is in the form of a bracelet which can be placed into the open position shown in FIG. 1A and the closed position in FIG. 1B. According to FIG. 1A, the Wearable Electronic Device 100 includes a pair of Recesses 105 that are configured to receive a pair of portable wireless audio devices that are inserted into the Recesses 105 such that the upper most portions of the Portable Wireless Audio Devices 150 are exposed including the driver used to generate audio.

As further shown in FIG. 1A, the Wearable Electronic Device 100 includes a Surface 125 in which the Recesses 105 are formed. Furthermore, the Wearable Electronic Device 100 includes a Recess Portion 120 that is opposite the Recesses 105 and the Surface 125 in position such that the (when inserted into the Recesses 105) the Portable Wireless Audio Devices 150 protrude into the Recess 120.

As described herein in greater detail, the Portable Wireless Audio Devices 150 can take the form of what is sometimes commonly referred to as “earbuds” that provide wireless audio when coupled to a portable electronic device, such as a mobile phone operating an application that is configured to generate audio for the Portable Wireless Audio Devices 150. It will be further understood that according to the embodiments illustrated by FIGS. 1A and 1B, the positioning of the Recesses 105 is configured to allow convenient insertion and removal of the Portable Wireless Devices 150 to/from the Recesses 105 such that the Wearable Electronic Device 100 remains securely attached to the user while the Portable Wireless Audio Devices 150 are inserted and/or withdrawn from the Wearable Electronic Device 100.

Still further, in some embodiments according to the invention, a retainer can be provided between the portion of the Wearable Electronic Device 100 that includes the Recess 120 and the portion that includes the Recesses 105 such that when the Wearable Electronic Device is in the open position, the Wearable Electronic Device 100 can remain securely attached to the user during insertion/removal of the Portable Wireless Audio Devices 150 by the retainer. As further shown in FIG. 1A, the Wearable Electronic Device 100 can also include a Hinged Portion 115 that allows for the Electronic Device 100 to be moved between the open and closed positions. Further, the Wearable Electronic Device 100 can include two moveable arc shaped portions 116 that are moveably connected together by the Hinged Portion 115. When in the open position shown in FIG. 1A, the two moveable are shaped portions 116 are separated from one another so that the Portable Wireless Audio Devices 150 can be removed or stored. When in the closed position shown in FIG. 1B, the two moveable are shaped portions 116 contact one another so that the Portable Wireless Audio Devices 150 can be securely stored inside the Wearable Electronic Device 100.

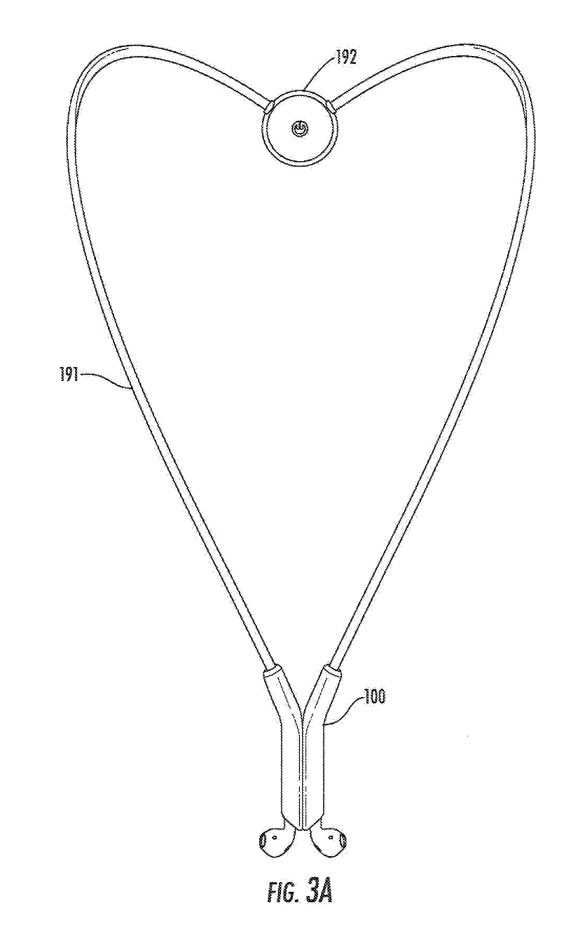

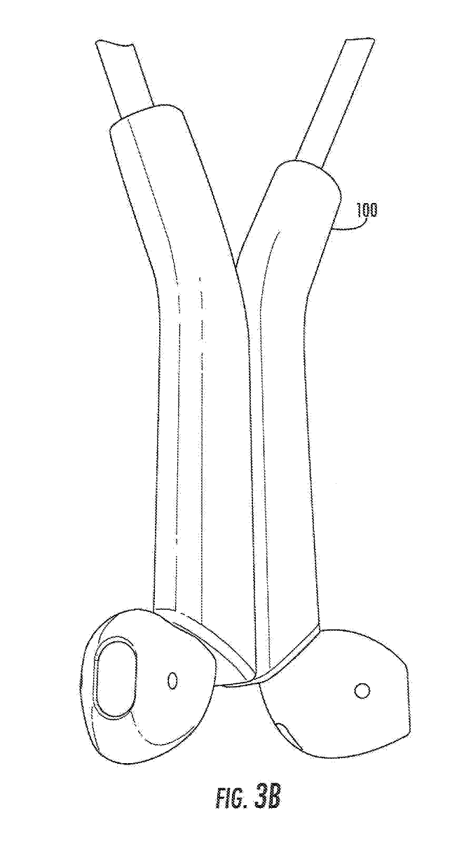

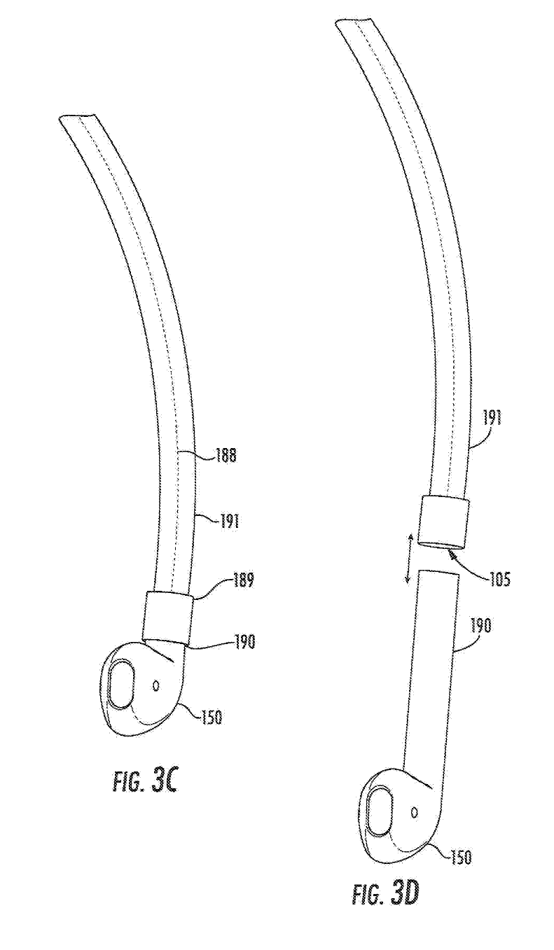

It will be understood that the Wearable Electronic Device 100 can be provided in any format that is convenient for the user to wear the Electronic Device 100. For example, FIGS. 3A to 3D illustrate a necklace format wherein the Wearable Electronic Device 100 is held by a cable around the user's neck. As further shown in FIG. 3A, the necklace configuration can include a Remote Battery 192 that is configured to provide power to the Wearable Electronic Device 100 via Cables 191. The Remote Battery 192 may be positioned behind the user's neck whereas the Wireless Audio Devices 150 may be suspended from Cables 191 in front of the user.

As further shown in FIG. 3D, the Cables 191 include Recess 105 that are configured to receive an insertion of the Portable Wireless Audio Devices 150 such that a Portion 190 thereof is snugly fits into the Recesses 105. In other words, in some embodiments according to the invention, the Recesses 105 are sized to have approximately the same width as the Portions 190 of the Wireless Audio Devices 150 so that the Portable Wireless Audio Devices 150 are retained inside the Recesses by compression provided by the Cable 191 at the Recess 105.

As further shown in FIG. 3C, the Cables 191 can be fitted with a Retainer 190 that can provide a magnetic coupling so that the left and right portions of the Cable 191 can be coupled together to secure the Portable Wireless Audio Devices 150 together. Still further, the Coupling 190 can also provide wireless charging of the Portable Audio Wireless Devices through the surface of the Cable 191 or otherwise while not being in direct contact the Portable Wireless Devices 150. It will be understood that the power can be provided from the Battery 192 to the coupling 190 for wireless coupling to the Portable Wireless Audio Devices 150 via a Cable 188 that is fitted either inside the Cable 191 or on the exterior of the Cable 191. In some embodiments, the coupling 190 may provide charging of the Portable Wireless Devices 150 through a direct electrical connection.

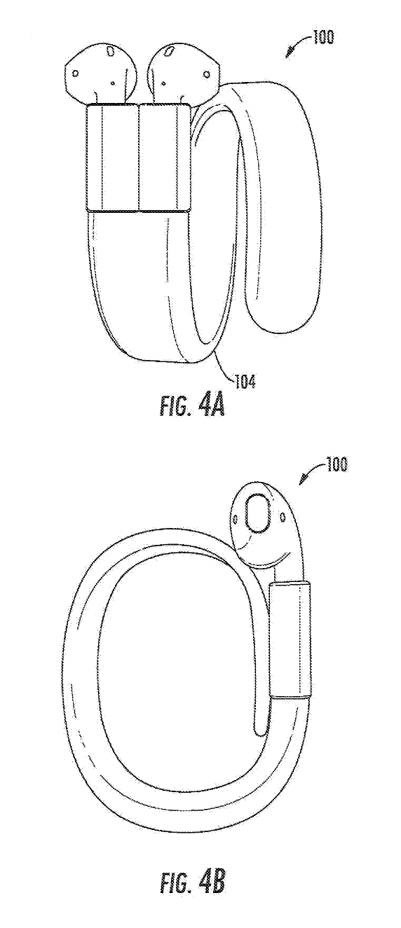

FIGS. 4A and 4B illustrate a format wherein the Wearable Electronic Device 100 is configured wrap around the user's wrist or other appendage by a portion 104 of a band. FIGS. 5A and 5B are another illustration of a format wherein the Wearable Electronic Device 100 is secured around the wrist or other appendage of a user. Still further, according to FIGS. 5A and 5B the Recesses 105 in which the Portable Wireless Audio Devices 150 are inserted can be located on opposite ends of the Wearable Electronic Device 100 as shown.

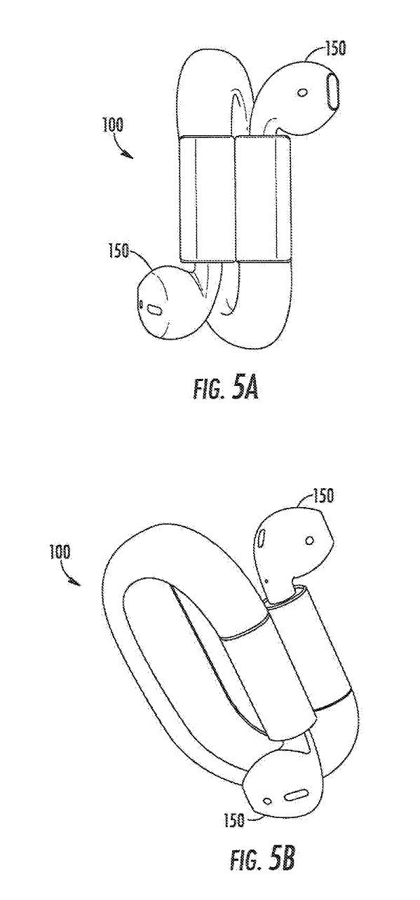

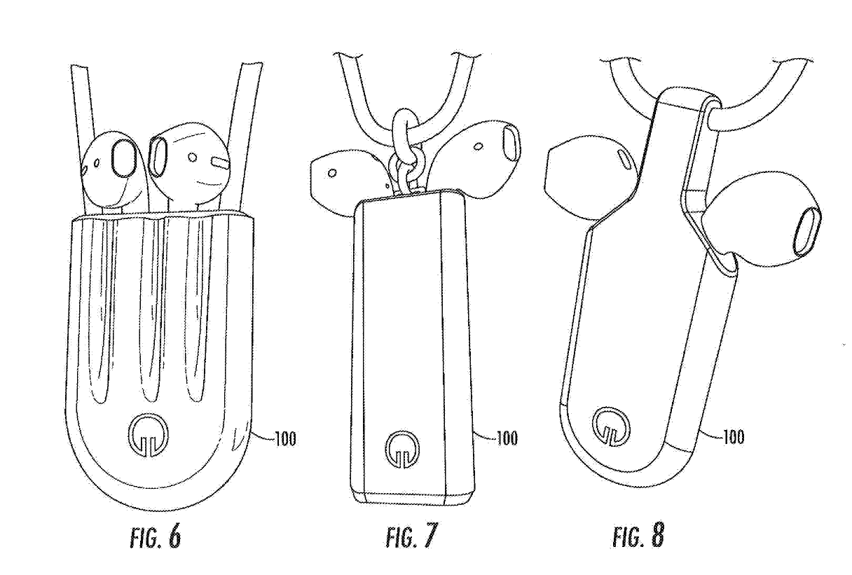

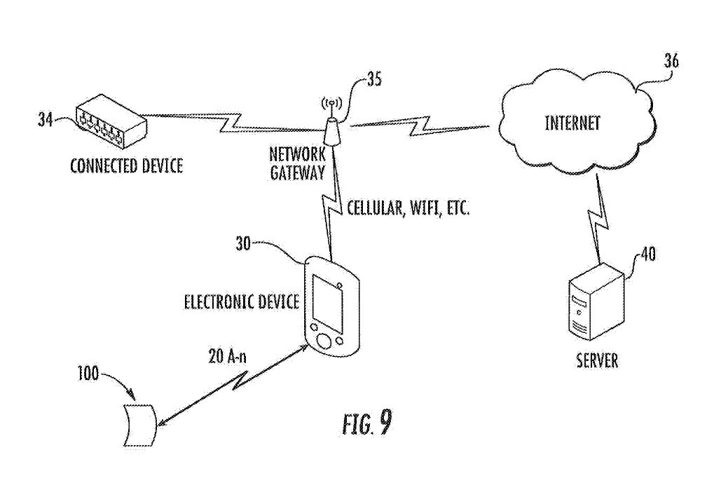

FIGS. 6-8 include various embodiments wherein the Recesses 105 are located on the same end of the Wearable Electronic Device 100 which is in the form factor of a USB or memory stick/key fob arrangement which can be worn around any appendage of the user including the neck, wrist, etc.

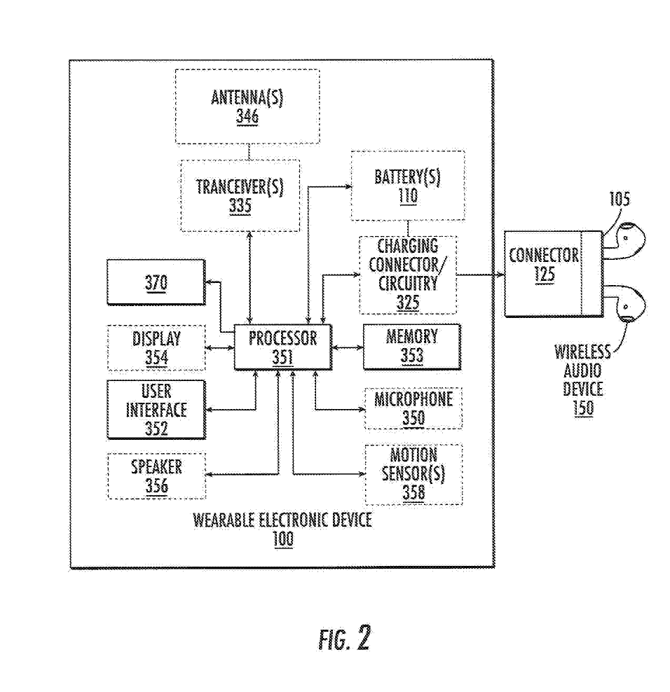

Referring now to FIG. 2, the wearable electronic device 100 may include a battery 110 that can be used to charge a portable, wireless audio device 150. The wearable electronic device 100 may be in any form-factor that is configured to promote the convenient carry and storage such as a bracelet, a necklace, a memory stick, a key fob, a smart watch or any other type of smart band. By connecting the portable, wireless audio device 150 to the wearable electronic device 100 via a charging connector 125, the battery 110 of the wearable electronic device 100 may charge (e.g., re-charge) a battery 460 of the portable, wireless audio device 150.

The charging connector 125 between the wearable electronic device 100 and the portable, wireless audio device 150 may be a wireless connection/link or a wired connection/link. For example, the charging connector 125 may include the recesses 105. Alternatively, the charging connector 125 may be a wireless charging connection/link such as inductive coupling inside the recess 105.

In some embodiments, the wearable electronic device 100 can also include a charging cable (i.e., a wired connector) that can be used to charge the battery 110 using the charging/connector circuit 325. The charging cable may be an integrated/built-in component of the wearable electronic device 100 that includes a plug/end (e.g., a “male plug”) that plugs into a charging port of the portable, wireless audio device 150. For example, the charging cable may be a Universal Serial Bus (USB) cable or a non-USB cable such as a Lightning® connector. Moreover, the charging cable can extend from a side surface or an underside of the wearable electronic device 100, and the charging cable may be permanently attached to/extend from various regions (e.g., the top surface) of the wearable electronic device 100. The present inventive entity also appreciates that the charging port can be on a bottom end of the wearable electronic device 100, the charging port may alternatively be on a top end or side portion/edge of the wearable electronic device 100.

In some embodiments, the wearable electronic device 100 may include a housing/recess for storing the charging cable so that the charging cable does not protrude from the wearable electronic device 100. As an alternative to the built-in charging cable, the wearable electronic device 100 may include a port (e.g., a port analogous to the charging port) into which a removable charging cable can be inserted and then connected to the charging port of the wearable electronic device 100. Moreover, in some embodiments, the wearable electronic device 100 may include circuitry configured to wirelessly transfer power to a charging cable/dongle that receives wireless power and that is connected to the charging port of the wearable electronic device 100.

The wearable electronic device 100 may, in some embodiments, include an integrated stand that a user can deploy when charging the wearable electronic device 100. For example, the integrated stand may maintain the position of the wearable electronic device 100 so that a charging connector/circuitry 325 and/or a speaker 356 faces a particular direction. Accordingly, the integrated stand may stabilize the wearable electronic device 100 to keep it from rolling on a surface, and/or falling off of the surface, and/or to improve the quality of sound from the speaker 356, when the charging connector 125 is in use.

The battery 110 may be a primary battery or a secondary battery of the wearable electronic device 100. Accordingly, in some embodiments, the wearable electronic device 100 may have more than one battery. Alternatively, the battery 110 may be the sole battery of the wearable electronic device 100.

As further shown in FIG. 2, the wearable electronic device 100 may further include a user interface 352, a processor (e.g., processor circuit) 351, a memory 353, a charging connector/circuitry 325, and at least one battery 110 that is connected to the charging connector/circuitry 325. In some embodiments, the charging connector/circuitry 325 may include the charging cable 225. Additionally, or alternatively, the charging connector/circuitry 325 may include wireless charging circuitry that is configured to wirelessly (e.g., via inductive coupling) charge the battery 460 of the portable, wireless audio device 150. Moreover, the wearable electronic device 100 may optionally include one or more antennas 346, one or more transceivers (e.g., one or more transceiver circuits) 335, a speaker 356, a display, one or more motion sensors 358 (e.g., gyroscopes or other motion sensors), and/or a microphone 350. The antenna(s) 346 and transceiver(s) 335 may provide short-range radio communications (e.g., Wi-Fi, Bluetooth, etc.), or other wireless communications, with the portable, wireless audio device 150.

In some embodiments, the wearable electronic device 100 may further include a haptic feedback device 370 that operates under the control of the processor. In operation, the haptic feedback device 370 can provide feedback to the wearer where at least one of the portable, wireless audio devices 150 is absent from the wearable electronic device 100 and the processor detects substantial movement away from the user's present location. In some embodiments, the haptic feedback device 370 can provide feedback to the wearer when the portable, wireless audio devices 150 is full charged or when the wearable electronic device 100 determines that the portable, wireless audio devices 150 have reached some low level of charge.

A transmitter portion of the short-range radio transceiver(s) 335 may convert information, which is to be transmitted by the wearable electronic device 100, into electromagnetic signals suitable for radio communications (e.g., to the portable, wireless audio device 150). A receiver portion of the short-range radio transceiver(s) 335 may demodulate electromagnetic signals, which are received by the wearable electronic device 100 from the portable, wireless audio device 150, to provide information contained in the signals in a format understandable to the processor 351 and/or a user of the wearable electronic device 100.

The wearable electronic device 100 is not limited to any particular combination/arrangement of the user interface 352 and the display 354. For example, the user interface 352 may be an input interface that accepts inputs (e.g., touch, click, motion, proximity, or keypad inputs) from a user. Moreover, the display 354 may be referred to as a user interface that provides graphical/visual outputs to the user. In some embodiments, the functions of the user interface 352 and the display 354 may optionally be provided by a touch screen through which the user can view information, such as computer-displayable text and/or images, provide input thereto, and otherwise control the wearable electronic device 100. Additionally, or alternatively, the wearable electronic device 100 may include a separate user interface 352 and display 354. For example, user input may be accepted through a touchpad or another user input interface that is separate from the display 354.

Referring still to FIG. 2, the memory 353 can store computer program instructions that, when executed by the processor circuit 351, carry out operations of the wearable electronic device 100 (e.g., operations of communicating with and/or charging the portable, wireless audio device 150). As an example, the memory 353 can be non-volatile memory, such as a flash memory, that retains the stored data while power is removed from the memory 353.

The wearable electronic device 100 may include a visual battery-life indicator. In some embodiments, the battery-life indicator may be displayed on a display 354. Alternatively, the battery-life indicator may be a standalone visual indicator of the charge of the battery(s) 110 of the wearable electronic device 100. Additionally, or alternatively, the battery-life indicator may visually indicate the charge of the battery 460 of the portable, wireless audio device 150. Accordingly, the battery-life indicator of the wearable electronic device 100 may indicate a battery level of at least one of the wearable electronic device 100 and the portable, wireless audio device 150. The battery-life indicator may thus indicate the progress of charging the portable, wireless audio device 150 (when the wearable electronic device 100 is connected to the portable, wireless audio device 150 via the charging connector 125), and/or indicate the capacity of the wearable electronic device 100 to charge the battery 460 of the portable, wireless audio device 150.

Referring now to FIG. 9, the wearable electronic device 100 according to present inventive concepts is illustrated within an operating environment. As illustrated in FIG. 9, the wearable electronic device 100 may be communicatively coupled to an electronic device 30 (e.g., the portable, wireless audio device 150) by one or more communication paths 20A-n. The communication paths 20A-n may include, for example, WiFi, USB, IEEE 1394, Bluetooth, Bluetooth Low-Energy, electrical wiring, and/or various forms of radio, though present inventive concepts are not limited thereto. The communication paths 20A-n may be used simultaneously and, in some embodiments, in coordination with one another. The wearable electronic device 100 may exchange data and/or requests with the electronic device 30.

The electronic device 30 may be in further communication with an external server 40 through a network 36. In some embodiments, the network 36 may be a large network such as the global network that is more commonly known as the Internet. The electronic device 30 may be connected to the network 36 through intermediate gateways such as the network gateway 35. The electronic device 30 may be connected to the network gateway 35 through various means. For example, the network gateway 35 may be a radio-based telecommunication gateway, such as a base station, and the electronic device 30 may communicate with the network gateway 35 via radio communication such as that commonly used in cellular telephone networks. In some embodiments, the network gateway 35 may be a network access point, and the electronic device 30 may communicate with the network gateway 35 via a wireless network (e.g., WiFi). The network gateway 35 may further communicate with the network 36 via a communication method that is similar to or different from the one used between the electronic device 30 and the network gateway 35. The communication paths described herein are not intended to be limiting. One of skill in the art will recognize that multiple technologies can be used for connectivity between the electronic device 30 and the server 40 without deviating from present inventive concepts.

The electronic device 30 may communicate with the server 40 to exchange information, data, and or requests. In some embodiments, the electronic device 30 may share data provided by the wearable electronic device 100 with the server 40. In some embodiments, the electronic device 30 may retrieve instructions and/or data from the server 40 responsive to input received from the wearable electronic device 100.

In some embodiments, the electronic device 30 may be communicatively coupled to a connected device 34. The connected device 34 can be any connected device that supports an associated application running in an operating environment of the electronic device 30. In some embodiments, the electronic device 30 may exchange data and/or control the connected device 34 responsive to input received from the wearable electronic device 100. Though illustrated as being connected to the connected device 34 through the network gateway 35, this illustration is not intended to be limiting. In some embodiments, the electronic device 30 may directly connect to the connected device 34 via similar communication paths as discussed with respect to communications paths 20A-n. For example, a path between the electronic device 30 and the connected device 34 may include, for example, WiFi, USB, IEEE 1394, Bluetooth, Bluetooth Low-Energy, electrical wiring, and/or various forms of radio, though present inventive concepts are not limited thereto.

In some embodiments, the input received from the wearable electronic device 100 may be transmitted to the electronic device 30. The input provided by the wearable electronic device 100 may be used to interact with applications running on the electronic device 30 so as to control operations of the wearable electronic device 100, the server 40 and/or the connected device 34.

One or more processors (e.g., the processor 451) may control the overall operation of the electronic device 30. The one or more processors may be configured to receive input provided from the wearable electronic device 100 and to execute operations of a common application programming interface (API) framework responsive to that input. In some embodiments, the processor(s) accomplish this by executing software or firmware stored in memory (e.g., the memory 453). The processor(s) may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices. The API may be a cross-platform API capable of receiving input at the electronic device 30 from the wearable electronic device 100 for interaction with connected devices.

By varying the operation of applications running within an operating environment of the electronic device 30, the wearable electronic device 100 may be utilized to seamlessly control devices connected to the electronic device 30, as described herein.

Accordingly, in some embodiments, the wearable electronic device 100 may be a smart remote control band that can control one or more other electronic devices, such as the portable, wireless audio device 150 (or an electronic device that is connected to the portable, wireless audio device 150). For example, the wearable electronic device 100 may be used to control gaming applications or music applications for one or more electronic devices 30 that are connected (e.g., wirelessly, communicatively coupled) to the wearable electronic device 100 and/or to the portable, wireless audio device 150. As an example, a user of the wearable electronic device 100 may speak commands into a speaker 356, and the command will be searched with all connected software platforms (e.g., third-party applications). Moreover, in some embodiments, a user's motions of the wearable electronic device 100, as detected by motion sensor(s) 358, may be used to command the gaming applications or music applications.

In some embodiments, a user's motions of the wearable electronic device 100, as detected by motion sensor(s) 358, may be used to command applications of the speaker 356 and/or the microphone 350. For example, the wearable electronic device 100 may be configured to receive a phone call by enabling the speaker 356 and/or the microphone 350 in response to detection by motion sensor(s) 358 of a lifting motion of the wearable electronic device 100. Accordingly, a user may conveniently respond to an incoming call by lifting the wearable electronic device 100 and talking through the wearable electronic device 100 without removing the wireless audio devices 150.

In some embodiments, the wearable electronic device 100 may be configured to perform an audio recording function by enabling the microphone 350 in response to detection by motion sensor(s) 358 of a lifting motion of the wearable electronic device 100. Accordingly, a user may create an audio recording by lifting the wearable electronic device 100 and talking to the wearable electronic device 100 without removing the wireless audio devices 150.

In some embodiments, the wearable electronic device 100 may be configured to recognize an audio pattern. For example, the processor 351 may be configured to recognize one or more code words or sounds that are received at the microphone 350. Accordingly, the user may initiate the call reception and/or audio recording by lifting the wearable electronic device and saying the one or more code words or sounds.

In some embodiments, one or more speakers and/or microphones of the wireless audio devices 150 inside of the wearable electronic device 100 may be used for these functions instead of the speaker 356 and/or the microphone 350 of the wearable electronic device 100.

Additionally, or alternatively, according to various embodiments of present inventive concepts, the wearable electronic device 100 may be configured to serve as an external battery (i.e., an external power source) that charges the portable, wireless audio device 150 (e.g., a smart phone or wireless headphones) via the charging connector 125, as discussed with respect to any of the embodiments illustrated herein.

Referring again to FIG. 2, In some embodiments according to the invention, the charging connector/circuitry 325 can support exchanging data with the earbuds which are coupled to the wearable electronic device 100 to determine parameters associated with the earbuds. It will also be understood that the functions of the charging connector/circuitry 325 can also include the ability to measure the power levels associated with the earbud as well as remaining charging time and profiles for safe charging of the earbuds. Accordingly, different types of the earbuds may be supported by the same bracelet and may be charged by the wearable electronic device by the charging connector circuitry 325 without violating the parameters associated with the particular earbuds. In further embodiments according to the invention, information can be exchanged between the wearable electronic device 100 and the earbuds to determine that the wireless earbuds are authorized for use with the wearable electronic device 100.

In still further embodiments according to the invention, it will be understood that when the earbuds are inserted into the wearable electronic device 100, the wireless earbuds may provide a wireless interface for the wearable electronic device when, for example, the wearable electronic device 100 does not include dedicated transceivers 335 and antennas 346 such that when the wireless earbuds are placed into the wearable electronic device 100, the wearable electronic device 100 is provided with a wireless interface that can allow the wearable electronic device 100 to perform functions that would otherwise not be possible without the wireless interface provided by the wireless earbuds. For example, in some embodiments according to the invention, the insertion of the wireless earbuds that provide the wireless interface to the wearable electronic device 100 can allow the wearable electronic device 100 to make payments, exchange data with other devices, measure or report health data associated with biosensors, and integrate with third party applications.

In still further embodiments according to the invention, the wearable electronic device 100 (with or without the insertion of the wireless earbuds) can connect to other electronic devices as part of the mesh or ad hoc network that can allow the wearable electronic device 100 to provide data to other devices via the mesh network and/or provide wireless data to the wearable electronic device from other devices on the network. For example, in some embodiments according to the invention, the wearable electronic device 100 may connect to a mesh network that is part of a gaming system that can use the wearable electronic device as an input device associated with use of the gaming system. In still further embodiments according to the invention, the wearable electronic device 100 can support an RFID interface that may allow payments using the wearable electronic device 100. In still further embodiments according to the invention, the haptic feedback 370 can be utilized to assist visually impaired users in navigating a local environment which is unfamiliar to the visually impaired user. For example, the haptic feedback 370 can vibrate in particular ways to que the visually impaired user as to the location of a particular item such as a doorway, desk, etc. Accordingly, the visually impaired user can be guided through an unknown environment by the haptic feedback 370.

Example embodiments of the present disclosure were described herein with reference to the accompanying drawings. Embodiments may take many different forms, however, and the present disclosure should not be construed as limited to the example embodiments set forth herein.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein. As used herein, the term “and/or” includes any and all combinations of one or more of the associated listed items.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, steps, operations, elements, and/or components, but do not preclude the presence or addition of one or more other features, steps, operations, elements, components, and/or groups thereof. Elements described as being “to” perform functions, acts and/or operations may be configured to or other structured to do so.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wired, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

In the drawings and specification, there have been disclosed example embodiments and, although specific terms are employed, they are used in a generic and descriptive sense only and not for purposes of limitation, the scope of the disclosure being set forth in the following claim(s).

What is claimed is:

1. A wearable electronic device comprising:
a hinge configured to move the wearable electronic device between an open position and a closed position;
first and second arc shaped portions moveable connected together at the hinge;
a first recess in a face the first arc shaped portion located opposite the hinge, wherein the face the first arc shaped portion is exposed in the open position and is hidden in the closed position;
a second recess in a face the second arc shaped portion located opposite the hinge, the first and second recesses being located in the first and second faces opposite one another, wherein the face the second arc shaped portion is exposed in the open position and is hidden in the closed position; and
a battery inside the first arc shaped portion, coupled to the first recess and configured electrically charge a portable wireless audio device when inserted into the first recess.

2. The device of claim 1 wherein the first and second arc shaped portions are configured to encircle a users wrist.

3. The device of claim 1 further comprising:
a transceiver circuit, operatively coupled to the first recess and configured to send/receive data to/from portable wireless audio device when inserted in the first recess.

4. The device of claim 1 wherein outer surfaces of the first and second arc shaped portions are polished.

5. The device of claim 3 further comprising:
a user interface circuit, operatively coupled to the transceiver circuit.

6. The device of claim 5 wherein the user interface circuit comprises a battery level indicator operatively coupled to the battery.

7. The device of claim 1 further comprising:
a charging circuit operatively coupled to the battery and configured to charge the battery.
